(19) United States
(12) Patent Application Publication
(10) Pub. No.: US 2014/0014701 A1
(43) Pub. Date: Jan. 16, 2014

(54) TEARING METHOD AND APPARATUS FOR TEARING POLARIZING PLATE

(71) Applicants: Jiasheng Lu, Shenzhen (CN); Desheng Yin, Shenzhen (CN)

(72) Inventors: Jiasheng Lu, Shenzhen (CN); Desheng Yin, Shenzhen (CN)

(73) Assignee: Shenzhen China Star Optoelectronics Technology Co. Ltd., Shenzhen, Guangdong (CN)

(21) Appl. No.: 13/640,746

(22) PCT Filed: Jul. 30, 2012
(86) PCT No.: PCT/CN12/79364

§ 371 Date: Oct. 12, 2012

(30) Foreign Application Priority Data
Jul. 13, 2012 (CN) 201210243531.4
Jul. 30, 2012 (CN) PCT/CN12/79364

(51) Int. Cl. B26F 3/02

(52) U.S. Cl. 225/1

(57) ABSTRACT

A tearing method for tearing a polarizing plate, including: after a tear-initiation edge of a polarizing plate defectively attached on a liquid crystal panel is torn away from the panel, turning on a pneumatic maintaining device to keep the tear-initiation edge at a torn-away state; moving the pneumatic maintaining device and a tearing platform such that the tear-initiation edge can be located in a tearing assembly; and clamping the tear-initiation edge in the tearing assembly and further tearing the polarizing plate by the relative movement between the tearing platform and the tearing assembly. The present disclosure further provides a tearing apparatus for tearing the polarizing plate. The tearing method and device allows the polarizing plate to be torn semi-automatically, improves the controllability of the tearing process of the polarizing plate, and further improves the yield rate of the panel as well as reduces the industry safety risks.

### BACKGROUND

1. Technical Field

The present disclosure relates to liquid crystal displaying technologies, and particularly, to a tearing apparatus and a tearing method for tearing a polarizing plate.

2. Description of Related Art

The polarizing plate tearing process is mainly used for tearing polarizing plates to allow the polarizing plates to be re-attached when there is any defect during the process of attaching the polarizing plates to the panels.

In the present tearing process of the polarizing plate, an edge of the polarizing plate is manually torn away from the panel and is further placed between the tearing rollers to allow the polarizing plate to be removed. Since the polarizing plate is soft and the torn edge thereof cannot maintain upright, therefore, the torn edge of the polarizing plate needs to be kept upright before being placed between the tearing rollers. However, in this way, the tearing process of the polarizing plate is carried out manually, especially the action of placing the torn edge of the polarizing plate between the tearing rollers, which increases industry safety risks easily. Additionally, since the operators for tearing the polarizing plate are different, the controllability of the process of tearing the polarizing plate is relatively low.

### SUMMARY

The present disclosure provides a tearing method for tearing a polarizing plate, including: after a tear-initiation edge of the polarizing plate defectively attached on a liquid crystal panel is torn away from the liquid crystal panel, turning on a pneumatic maintaining device to keep the tear-initiation edge at a torn-away state; moving the pneumatic maintaining device and a tearing platform on which the liquid crystal panel is placed to allow the tear-initiation edge to be located in a tearing assembly which includes a front tearing roller and a rear tearing roller for clamping the polarizing plate during the tearing process of the polarizing plate and a tearing clamper for clamping the tear-initiation edge and further tearing the polarizing plate; and clamping the tear-initiation edge in the tearing assembly and thus tearing the polarizing plate by the relative movement between the tearing platform and the tearing assembly.

Preferably, an angle of air supplied from the pneumatic maintaining device is adjustable.

Preferably, in the process of tearing the polarizing plate by the relative movement between the tearing platform and the tearing assembly, the liquid crystal panel abuts an abutting roller located under the rear tearing roller.

Preferably, the step of turning on a pneumatic maintaining device to keep the tear-initiation edge at a torn-away state includes:

facing the pneumatic maintaining device towards one side of the tear-initiation edge originally contacting the liquid crystal panel; and

turning on the pneumatic maintaining device to supply air of high pressure to keep the tear-initiation edge at the torn-away state.

Preferably, the step of moving the pneumatic maintaining device and a tearing platform on which the liquid crystal panel is placed to allow the tear-initiation edge to be located in a tearing assembly includes:

simultaneously moving the pneumatic maintaining device and the tearing platform to allow the tear-initiation edge to abut the rear tearing roller; and

pressing the front tearing roller down to allow the tear-initiation edge to be located between the front tearing roller and the rear tearing roller.

Preferably, the step of clamping the tear-initiation edge in the tearing assembly and further tearing the polarizing plate includes:

moving the tearing clamper to be located above the front tearing roller and the rear tearing roller; and

after the tear-initiation edge enters the tearing clamper, clamping the tear-initiation edge in the tearing clamper and further tearing the polarizing plate.

The present disclosure further provides another tearing method for tearing a polarizing plate, including: after a tear-initiation edge of the polarizing plate defectively attached on a liquid crystal panel is torn away from the liquid crystal panel, turning on a pneumatic maintaining device to keep the tear-initiation edge at a torn-away state; moving the pneumatic maintaining device and a tearing platform on which the liquid crystal panel is placed to allow the tear-initiation edge to be located in the tearing assembly; and clamping the tear-initiation edge in the tearing assembly and further tearing the polarizing plate.

Preferably, an angle of air supplied from the pneumatic maintaining device is adjustable.

Preferably, when the polarizing plate is torn away from the liquid crystal panel, the liquid crystal panel abuts an abutting roller located under the rear tearing roller.

Preferably, the step of turning on a pneumatic maintaining device to keep the tear-initiation edge at a torn-away state includes:

facing the pneumatic maintaining device towards one side of the tear-initiation edge originally contacting the liquid crystal panel; and

turning on the pneumatic maintaining device to supply air of high pressure to keep the tear-initiation edge at the torn-away state.

Preferably, the tearing assembly includes a front tearing roller, a rear tearing roller, and a tearing clamper; the front tearing roller and the rear tearing roller are used for clamping the polarizing plate during the process of tearing the polarizing plate, and the tearing clamper is used for clamping the tear-initiation edge and tearing the polarizing plate.

Preferably, the step of moving the pneumatic maintaining device and a tearing platform on which the liquid crystal panel is placed to allow the tear-initiation edge to be located in a tearing assembly includes:

simultaneously moving the pneumatic maintaining device and the tearing platform at the same time to allow the tear-initiation edge to abut the rear tearing roller; and

pressing the front tearing roller down to allow the tear-initiation edge to be located between the front tearing roller and the rear tearing roller.

Preferably, the step of clamping the tearing clamper in the tearing assembly and further tearing the polarizing plate includes:

moving the tearing clamper to be located above the front tearing roller and the rear tearing roller; and

after the tear-initiation edge enters the tearing clamper, clamping the tear-initiation edge in the tearing clamper and further tearing the polarizing plate.

The present disclosure also provides a tearing apparatus for tearing a polarizing plate, including:

a maintaining module for turning on a pneumatic maintaining device after a tear-initiation edge of the polarizing plate defectively attached on a liquid crystal panel is torn away from the liquid crystal panel so that the pneumatic maintaining device is capable of keeping the tear-initiation edge at a torn-away state;

a moving module for moving the pneumatic maintaining device and a tearing platform on which the liquid crystal panel is placed to allow the tear-initiation edge to be located in the tearing assembly; and

a tearing module for clamping the tear-initiation edge in the tearing assembly and further tearing the polarizing plate.

Preferably, the maintaining module includes an arranging unit and a maintaining unit, the arranging unit is used for arranging the pneumatic maintaining device in a way of facing towards one side of the tear-initiation edge originally contacting the liquid crystal panel, and the maintaining unit is used for turning on the pneumatic maintaining device to supply air of high pressure to keep the tear-initiation edge at the torn-away state.

Preferably, the tearing assembly includes a front tearing roller, a rear tearing roller, and a tearing clamper; the front tearing roller and the rear tearing roller are used for clamping the polarizing plate during the process of tearing the polarizing plate, and the tearing clamper is used for clamping the tear-initiation edge and tearing the polarizing plate.

Preferably, the moving module includes a first moving unit and a pressing unit; the first moving unit is used for moving the pneumatic maintaining device and the tearing platform simultaneously to allow the tear-initiation edge to abut the rear tearing roller, and the pressing unit is used for pressing the front tearing roller down to allow the tear-initiation edge to be located between the front tearing roller and the rear tearing roller.

Preferably, the tearing module includes a second moving unit and a tearing unit, the second moving unit is used for moving the tearing clamper to be located above the front tearing roller and the rear tearing roller, and the tearing unit is used for clamping the tear-initiation edge in the tearing clamper and tearing the polarizing plate after the tear-initiation edge enters the tearing clamper.

In the tearing method of the embodiment, after the tear-initiation edge of the polarizing plate attached to the liquid crystal panel is torn away from the liquid crystal panel and the liquid crystal panel is placed on the tearing platform, the pneumatic maintaining device is turned on to supply high pressure air to keep the tear-initiation edge at the torn-away state; then the tearing platform and pneumatic maintaining device are moved to allow the tear-initiation edge to be located in the tearing assembly, thus, after the tear-initiation edge is clamped by the tearing assembly, the polarizing plate can be torn from the liquid crystal panel by the relative movement between the tearing platform and the tearing assembly. With the tearing method of the present disclosure, the polarizing plate can be torn semi-automatically, which simplifies manual operation and improves the controllability of the tearing process of the polarizing plate as well as reduces the industrial safety risks.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a flow chart of a tearing method for tearing a polarizing plate in accordance with an embodiment of the present disclosure;

FIG. 2 is a flow chart of the step of keeping the tear-initiation edge of the polarizing plate at a torn-away state of the tearing method of FIG. 1;

FIG. 3 is a schematic view showing the process of keeping the tear-initiation edge of the polarizing plate at the torn-away state by a pneumatic maintaining device;

FIG. 4 is a flow chart of the step of moving a tearing platform and a pneumatic maintaining device of the tearing method of FIG. 1;

FIG. 5 is a flow chart of the step of tearing the polarizing plate of the tearing method of FIG. 1;

FIGS. 6a to 6e are schematic views showing the processes of tearing the polarizing plate;

FIG. 7 is a schematic view of a tearing apparatus for tearing a polarizing plate in accordance with an embodiment of the present disclosure;

FIG. 8 is a schematic view of a maintaining module of the tearing apparatus of FIG. 7;

FIG. 9 is a schematic view of a moving module of the tearing apparatus of FIG. 7;

FIG. 10 is a schematic view of a tearing module of the tearing apparatus of FIG. 7.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

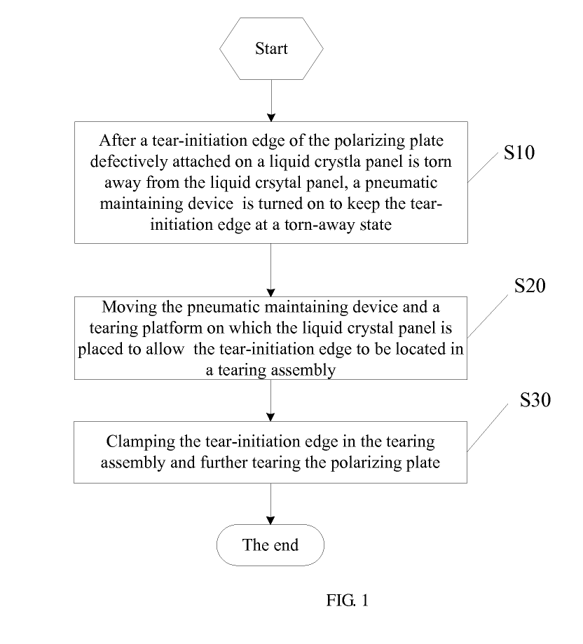

Referring to FIG. 1, which is a flow chart of a tearing method for tearing a polarizing plate in accordance with an embodiment of the present disclosure. The tearing method includes:

Step S10, after a tear-initiation edge of the polarizing plate defectively attached on a liquid crystal panel is manually torn, turning on a pneumatic maintaining device to keep the tear-initiation edge at a torn-away state.

Step S20, moving the maintaining pneumatic maintaining device and the tearing platform on which the liquid crystal panel is placed to allow the tear-initiation edge to be located in the tearing assembly.

Step S30, clamping the tear-initiation edge in the tearing assembly and further tearing the polarizing plate.

When there is any defect in the process of attaching the polarizing plate, the polarizing plate needs to be torn and re-attached. After the liquid crystal panel with the defectively attached polarizing plate is placed on the tearing platform, the tearing process of the polarizing plate begins. That is, as the tearing platform moves, the polarizing plate can be torn semi-automatically by the tearing assembly.

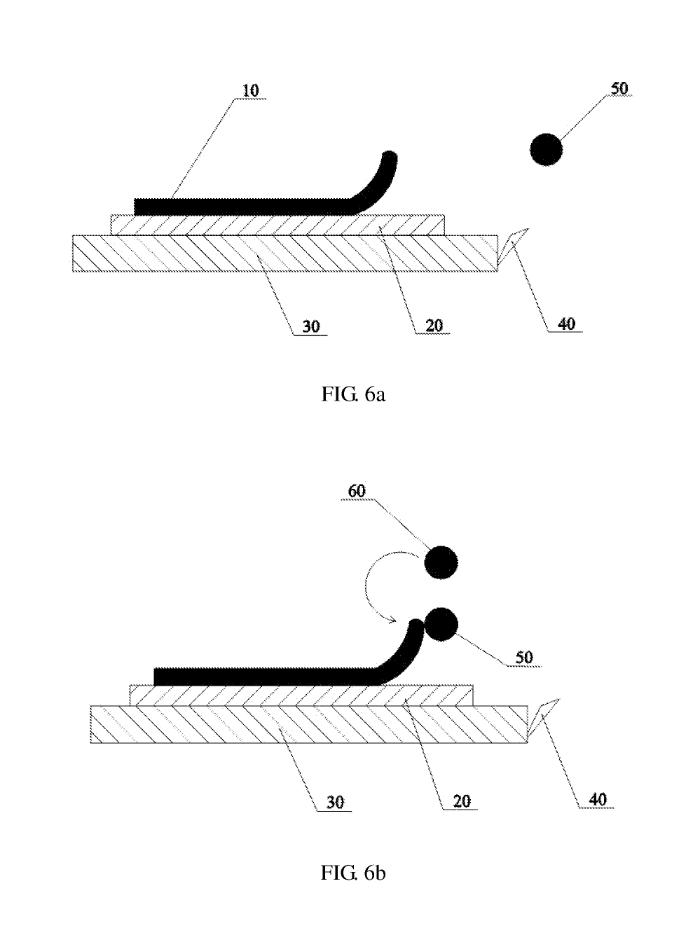

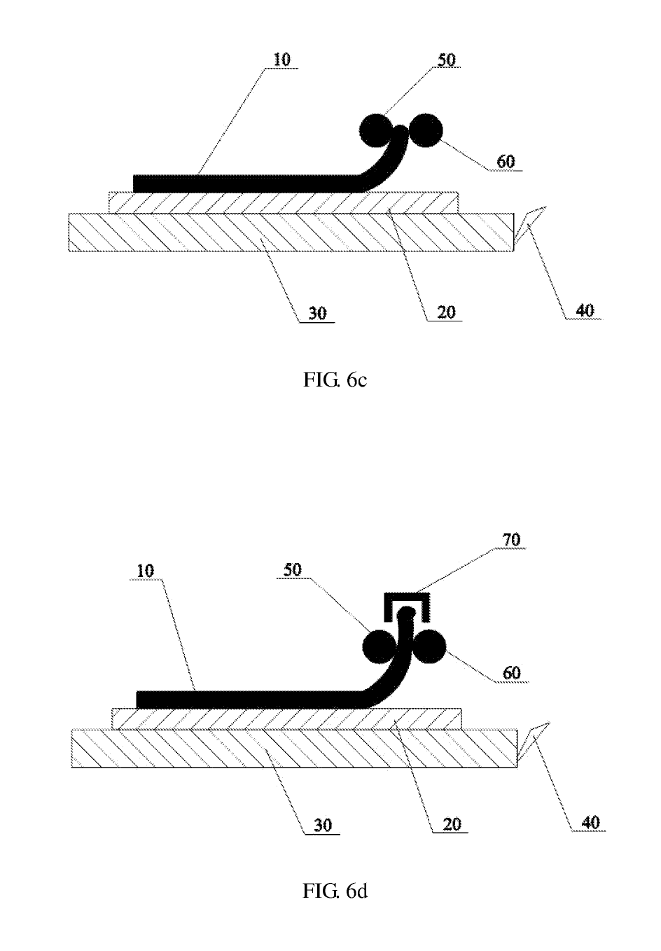

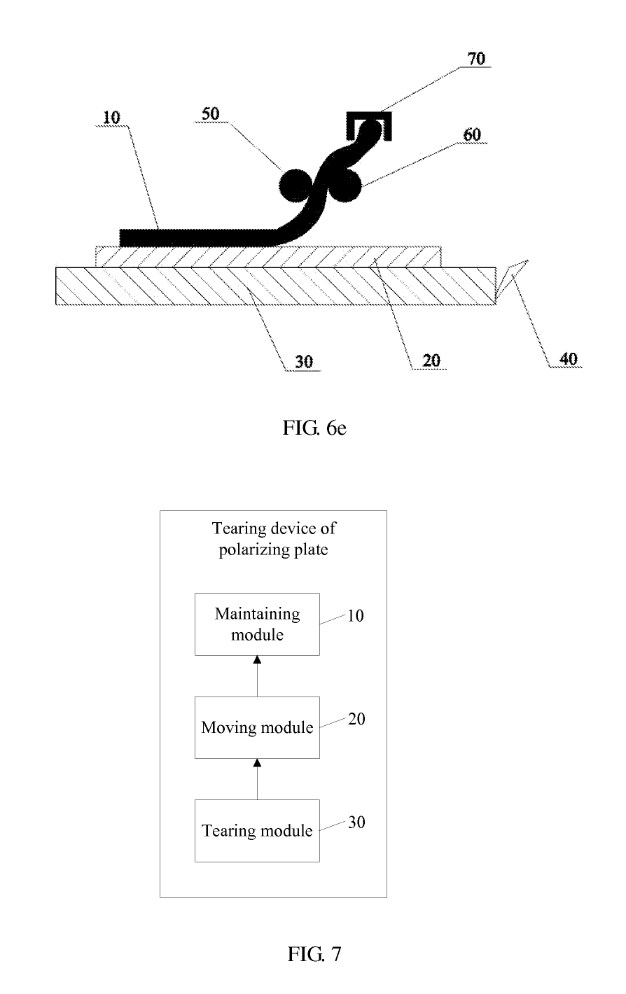

Referring also to FIG. 3 and FIGS. 6a to 6e, in which FIG. 3 is a schematic view showing the process of keeping the tear-initiation edge at the torn-away state by the pneumatic maintaining device, and FIGS. 6a to 6e are schematic views showing the processes of tearing the polarizing plate.

In the embodiment, one edge of the defectively attached polarizing plate can be at first manually torn away from the liquid crystal panel. Here, the edge being torn can be referred to be the tear-initiation edge 11. Specifically, in the process of tearing the tear-initiation edge 11, a knife can be used to slip into the tear-initiation edge at first, then the tear-initiation edge 11 can be held and torn away from the liquid crystal panel 20 for a certain length. After the liquid crystal panel with the polarizing plate defectively attached thereon is placed on the tearing platform 30, the pneumatic maintaining device 40 is turned on to supply air of high pressure, which is capable of keeping the tear-initiation edge 11 at the torn-away state before the polarizing plate is transferred to the tearing assembly.

After the liquid crystal panel 20 with the polarizing plate 10 attached thereon is placed on the tearing platform 30, the tearing platform 30 move towards the tearing assembly 30 to allow the tear-initiation edge to be located in the tearing assembly. As shown in FIGS. 6a to 6e, in the embodiment, the tearing assembly 30 includes a front tearing roller 50, a rear tearing roller 60, and a tearing clamper 70. The front tearing roller 50 and the rear tearing roller 60 are used for clamping the polarizing plate 10 during the process of tearing the polarizing plate. The tearing clamper 70 is used for clamping the tear-initiation edge 11 and further tearing the polarizing plate 10. As shown in FIG. 3, the distance between the rear tearing roller 60 and the tearing platform is h1. After the polarizing plate 10 enters the tearing assembly 30, as the tearing platform moves along the same direction, since the tearing assembly is clamped by the tearing assembly 30, the polarizing plate can be torn with the relative movement of the tearing platform 30 to the tearing assembly.

In the tearing method of the embodiment, after the tear-initiation edge of the polarizing plate 10 attached to the liquid crystal panel 20 is torn away from the liquid crystal panel and the liquid crystal panel 20 is placed on the tearing platform 30, the pneumatic maintaining device 40 is turned on to supply high pressure air to keep the tear-initiation edge at the torn-away state; then the tearing platform 30 and pneumatic maintaining device 40 are moved to allow the tear-initiation edge 11 to be located in the tearing assembly 30, thus, after the tear-initiation edge 11 is clamped by the tearing assembly 30, the polarizing plate 10 can be torn away from the liquid crystal panel 20 by the relative movement between the tearing platform 30 and the tearing assembly. With the tearing method of the present disclosure, the polarizing plate can be removed semi-automatically, which simplifies manual operation and improves the controllability of the tearing process of the polarizing plate 10 as well as reduces the industrial safety risks.

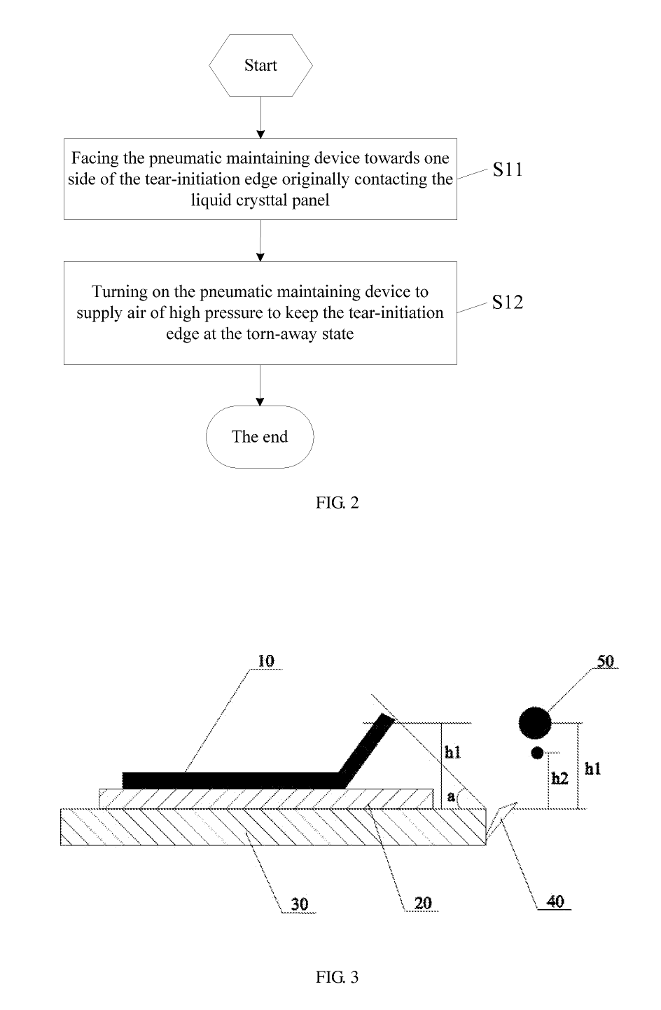

Referring to FIG. 2, which is a flow chart of the step of keeping the tear-initiation edge at the torn-away state. In the embodiment, the step S10 specifically includes:

Step S11, facing the pneumatic maintaining device towards one side of the tear-initiation edge originally contacting the liquid crystal panel by the pneumatic maintaining device;

Step S12, turning on the pneumatic maintaining device to allow the pneumatic maintaining device to supply air of high pressure to keep the tear-initiation edge at the torn-away state.

Referring to FIG. 3, which is a schematic view showing the process of keeping the tear-initiation edge at the torn-away state by the pneumatic maintaining device.

When securing the pneumatic maintaining device 40 on the tearing platform 30, the pneumatic maintaining device 40 is disposed in the way of facing towards the side of the polarizing plate originally contacting the liquid crystal panel 20. The pneumatic maintaining device 40 is then turned on to supply air of high pressure. In the embodiment, the pressure of the air supplied from the pneumatic maintaining device 40 can be adjusted. Additionally, the pneumatic maintaining device 40 can be the one with the adjustable air angle. After the pressure and the angle of the air supplied from the pneumatic maintaining device 40 are properly set, the tear-initiation edge 11 can be kept at the torn-away state.

In the embodiment, as shown in FIG. 3, an abutting roller (not shown in the figure) is disposed below the rear tearing roller 60 for abutting the liquid crystal panel 20 during the process of tearing the polarizing plate. The distance between the abutting roller and the tearing platform 30 is h2. In FIG. 3, “a” is referred to the angle of the air supplied from the pneumatic maintaining device 40.

The value of h2 needs to be varied in an appropriate range. If h2 is too large, the liquid crystal panel 20 may be heavily bent during the process of tearing the liquid crystal panel 20, which may break the liquid crystal panel 20. If h2 is too small, the liquid crystal panel 20 is too close to the abutting roller and the liquid crystal panel 20 may be scratched when the tearing platform 30 moves.

When the value of h2 is determined, since the rear tearing roller 60 is located above the abutting roller, therefore, it is required that h1 be larger than h2. If h1 is too large, in order to keep the tear-initiation edge 11 abutting the rear tearing roller 60, the tear-initiation edge 11 should be large enough, which may increase the risk of breaking the liquid crystal panel 20. Therefore, in the premise of keeping h1 being larger than h2, it is desirable to keep h1 small.

In order to keep the polarizing plate 10 abutting the rear tearing roller 60, the distance between the tearing platform 30 and the line cooperating with the tearing platform 30 to form the angle a of air supplied from of the pneumatic maintaining device 40 is required to be larger than h1. In the practical process of tearing the polarizing plate 10, since the angle of the pneumatic maintaining device 40 can be adjusted, the angle a can accordingly adjusted according to different requirements.

As the tearing platform 30 moves, the pneumatic maintaining device 40 is arranged to face towards the side of the tear-initiation edge 11 originally contacting the liquid crystal panel 20; then the pneumatic maintaining device 40 is turned on to blow air of high pressure onto the tear-initiation edge 11 of the polarizing plate 10 and thus keeps the tear-initiation edge 11 at the torn-away state. This can allow the polarizing plate 10 to be torn semi-automatically and further improves the controllability of the tearing process of the polarizing plate 10, and thus improves the yield rate of the liquid crystal panel 20.

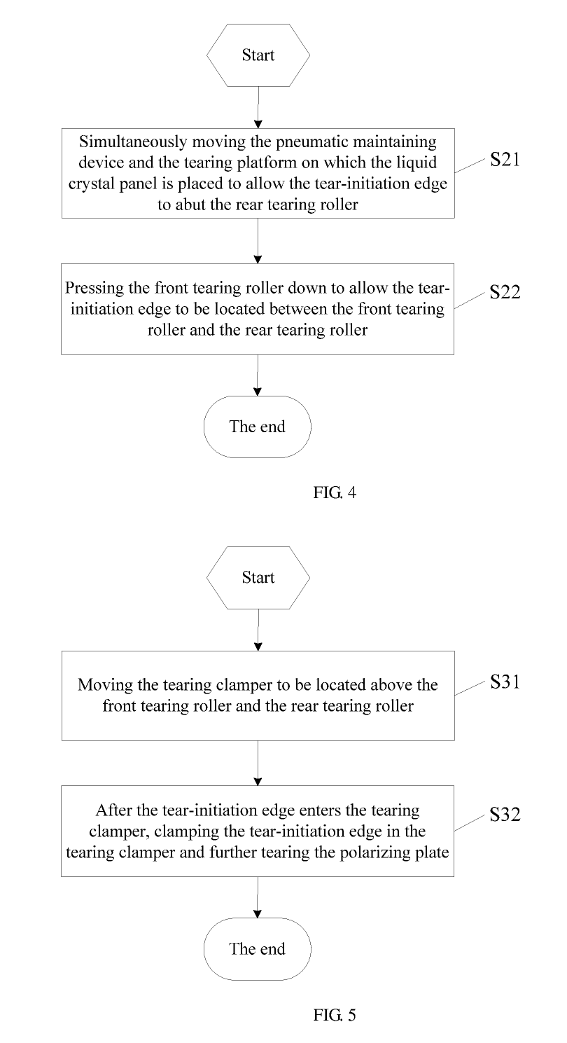

Referring to FIG. 4, which is a flow chart of the step S20. In the embodiment, the step S20 specifically includes:

Step S21, simultaneously moving the pneumatic maintaining device and the tearing platform to allow the tear-initiation edge to abut the rear tearing roller.

Step S22, pressing the front tearing roller down to allow the tear-initiation edge to be located between the front tearing roller and the rear tearing roller.

Referring to FIG. 5, which is a flow chart of the step S30. In the embodiment, the step S30 specifically includes:

Step S31, moving the tearing clamper to be located above the front tearing roller and the rear tearing roller.

Step S32, after the tear-initiation edge enters the tearing clamper, clamping the tear-initiation edge in the tearing clamper and further tearing the polarizing plate.

Referring also to FIGS. 6a and 6b, in which FIG. 6a schematically shows the process of placing the liquid crystal panel on the tearing platform and moving the tear-initiation edge into the tearing assembly and FIG. 6b schematically shows the process of pressing the front tearing roller down after the tear-initiation edge abuts the rear tearing roller.

As shown in FIG. 6a, after the tear-initiation edge 11 of the polarizing plate is torn away from the liquid crystal panel 20 for an appropriate length and the liquid crystal panel 20 with the polarizing plate 10 attached thereon is placed on the tearing platform 30, the tearing platform 30 and the pneumatic maintaining device 40 are simultaneously moved to allow the pneumatic maintaining device 40 to supply air of high pressure to keep the tear-initiation edge 11 at the torn-away state as the tearing platform 30 moves. During the process, as shown in FIG. 6b, the front tearing roller 50 is distant away from the rear tearing roller 60 and is located above the rear tearing roller 60. After the tear-initiation edge 11 abuts the rear tearing roller 60, the front tearing roller 50 is pressed down to move along the direction pointed by the arrow shown in FIG. 6b to be located on the same horizontal level as the rear tearing roller 60, which allows the front tearing roller 50 and the rear tearing roller 60 to clamp the tear-initiation edge 11 therebetween.

After the tearing platform 30 and the pneumatic maintaining device 40 are simultaneously moved to allow the tear-initiation edge 11 to abut the rear tearing roller 60, the front tearing roller 50 is pressed down such that the tear-initiation edge 11 can be located between the front tearing roller 50 and the rear tearing roller 60. Thus, the front tearing roller 50 and the rear tearing roller 60 are capable of clamping the tear-initiation edge 11. This can promise that the tear-initiation edge 11 is capable of entering the tearing clamper 11 as the tearing platform 30 moves on.

Referring also to FIGS. 6c, 6d, and 6e, in which FIG. 6c schematically shows the tearing clamper is properly positioned, FIG. 6d schematically shows the tear-initiation edge enters the tearing clamper, and FIG. 6e schematically shows the process that the tearing clamper champs the tear-initiation edge and further tears the polarizing plate.

A shown in FIG. 6c, after the front tearing roller 50 is pressed down to allow the tear-initiation edge 11 to be clamped between the front tearing roller 50 and the rear tearing roller 60, the tearing clamper 70 is properly positioned, that is, the tearing clamper 70 is moved to be located above the front tearing roller 50 and the rear tearing roller 60. As shown in FIG. 6d, as the tearing platform 30 moves on, the front tearing roller 50 and the rear tearing roller 60 clamps the tear-initiation edge 11 of the polarizing plate 10 to gradually tear the rest part of the polarizing plate 10 attached on the liquid crystal panel 20. During the process, the polarizing plate 10 extends upwards between the front tearing roller 50 and the rear tearing roller 60 to allow the tear-initiation edge 11 to enter the tearing clamper 70. As shown in FIG. 6e, after the tearing clamper 70 is determined to enter to tearing clamper 70, the tearing clamper 70 clamps the polarizing plate 10. As the tearing platform 30 moves, the tearing clamper 70 moves along the same direction as the tearing platform 30. Since the front tearing roller 50 and the rear tearing roller 60 are fixed, therefore, the polarizing plate 10 is capable of extending upwards between the front tearing roller 50 and the rear tearing roller 60 by being clamped by the tearing clamper 70. In this way, the polarizing plate 10 can be completely torn from the liquid crystal panel 20 to finish the process of tearing the polarizing plate 10.

After the tear-initiation edge 11 is clamped between the front tearing roller 50 and the rear tearing roller 60, the tearing clamper 70 is moved to be located above the front tearing roller 50 and the rear tearing roller 60; thus, after the tear-initiation edge 11 is clamped in the tearing clamper 70, the tearing clamper 70 is capable of tearing the polarizing plate 10 to completely tear the polarizing plate 10 away from the liquid crystal panel 20. This allows the polarizing plate 10 to be torn semi-automatically, simplifies manual tearing of the polarizing plate 10, and improves the yield rate as well as reduces the industry safety risks.

Referring to FIG. 7, which is a schematic view of a tearing apparatus for tearing the polarizing plate. In the embodiment, the tearing apparatus includes a maintaining module 001, a moving module 002, and a tearing module 003. The maintaining module 001 is used for turning on a pneumatic maintaining device to keep a tear-initiation edge of the polarizing plate at the torn-away state after the tear-initiation edge is torn away from the liquid crystal panel. The moving module 002 is used for moving the pneumatic maintaining device and a tearing platform on which the liquid crystal panel is placed such that the tear-initiation edge can be located in a tearing assembly. The tearing module 003 is used for clamping the tear-initiation edge in the tearing assembly and further tearing the polarizing plate.

When there is any defect in the process of attaching the polarizing plate and the polarizing plate needs to be re-attached, the liquid crystal panel with the polarizing plate attached thereon is placed on the tearing platform. The tearing process of the polarizing plate thus begins, in which the polarizing plate is torn by the tearing assembly as the tearing platform moves.

Referring also to FIG. 3 and FIGS. 6a to 6e, in which FIG. 3 schematically shows the process of keeping the tear-initiation edge at the torn-away state by the pneumatic maintaining device and FIGS. 6a to 6e schematically shows the tearing process of the polarizing plate.

In the embodiment, one edge of the defectively attached polarizing plate 10 can be at first manually torn away from the liquid crystal panel. Here, the edge being torn can be referred to be the tear-initiation edge 11. Specifically, in the process of tearing the tear-initiation edge 11, a knife can be used to slip into the tear-initiation edge 11 of the polarizing plate 10 at first, then the tear-initiation edge 11 can be held and torn away from the liquid crystal panel for a certain length. After that, the liquid crystal panel 20 can be placed on the tearing platform 30. During the process of transferring the polarizing plate 10 into the tearing assembly 30, in order to keep the tear-initiation edge at the torn-away state, the maintaining module 001 uses the air supplied from the pneumatic maintaining device 40 to keep tear-initiation edge 11 at the torn-away state.

After the liquid crystal panel with the polarizing plate 10 attached thereon is placed on the tearing platform 30, the moving module 002 moves the tearing platform towards the tearing assembly 30 to allow the tear-initiation edge 11 to be located in the tearing assembly. As shown in FIGS. 6a to 6e, in the embodiment, the tearing assembly includes a front tearing roller 50, a rear tearing roller 60, and a tearing clamper 70. The front tearing roller 50 and the rear tearing roller 60 are used for clamping the polarizing plate 10 as the polarizing plate 10 moves. The tearing clamper 70 is used for clamping the tear-initiation edge 11 and further tearing the polarizing plate 10. As shown in FIG. 3, the distance between the rear tearing roller 60 and the tearing platform is h1. After the polarizing plate 10 enters the tearing assembly, the tearing module 003 tears the polarizing plate 10 by clamping the polarizing plate 10 in the tearing assembly and by the relative movement between the tearing platform 30 and the tearing assembly. In this way, the polarizing plate 10 is completely torn away from the liquid crystal panel to finish the process of tearing the polarizing plate.

In the tearing apparatus of the present disclosure, after the tear-initiation edge 11 of the polarizing plate 10 attached on the liquid crystal panel 20 is torn away from the liquid crystal panel and the liquid crystal panel is placed on the tearing platform 30, the pneumatic maintaining device 40 is turned on to supply air of high pressure to keep the tear-initiation edge 11 at the torn-away state; then the tearing assembly and the pneumatic maintaining device 40 are moved to allow the tear-initiation edge 11 to be located in the tearing assembly; after the tearing assembly clamps the tear-initiation edge 11, the polarizing plate 10 is torn away from the liquid crystal panel by the relative movement between the tearing platform 30 and the tearing assembly. In this way, the process of tearing the polarizing plate 10 can be finished. This allows the polarizing plate 10 to be torn semi-automatically, simplifies manual operation, reduces the industry safety risks, and further improves the controllability of the process of tearing the polarizing plate 10.

Referring to FIG. 8, which is a schematic view of the maintaining module. In the embodiment, the maintaining module 001 includes an arranging module 0011 and a maintaining unit 0012. The arranging module 0011 is used for arranging the pneumatic maintaining device in a way of facing towards one side of the tear-initiation edge 11 originally contacting the liquid crystal panel. The maintaining unit 0012 is used for turning on the pneumatic maintaining device and keeping the tear-initiation edge at the torn-away state by the air of high pressure supplied from of the pneumatic maintaining device.

Referring also to FIG. 3, the pneumatic maintaining device 40 is secured on the tearing platform 30 and is arranged to face the side of the tear-initiation edge 11 originally contacting the liquid crystal panel by the arranging unit 0011. The maintaining unit 0012 then turns on the pneumatic maintaining device 40 to supply air of high pressure. In the embodiment, the pressure of the air supplied from the pneumatic maintaining device 40 can be adjusted. The angle of the pneumatic maintaining device 40 is also adjustable. After the pressure of the air supplied from the pneumatic maintaining device 40 and the angle of the pneumatic maintaining device 40 are properly set, the pneumatic maintaining device 40 can be kept at the torn-away state.

In the embodiment, as shown in FIG. 3, an abutting roller (not shown in the drawing) is disposed under the rear tearing roller 60 for abutting the liquid crystal panel during the process of tearing the polarizing plate 10. The distance between the abutting roller and the tearing platform 30 is h2, and “a” refers to the angle of the air supplied from the pneumatic maintaining device 40.

The value of h2 should be varied in an appropriate range. If h2 is too large, the liquid crystal panel 20 may be heavily bent during the process of tearing the liquid crystal panel 20, which may break the liquid crystal panel 20. If h2 is too small, the liquid crystal panel 20 is too close to the abutting roller and the liquid crystal panel 20 may be scratched as the tearing platform 30 moves.

When the value of h2 is determined, since the rear tearing roller 60 is located above the abutting roller, therefore, it is required that h1 be larger than h2. If h2 is too large, in order to keep the tear-initiation edge 11 abutting the rear tearing roller 60, the tear-initiation edge 11 should be large enough, which may increase the risk of breaking the liquid crystal panel 20. Therefore, in the premise of keeping h1 being larger than h2, it is desirable to keep h1 small.

In order to keep the polarizing plate 10 abutting the rear tearing roller 60, the distance between the tearing platform 30 and the line which cooperates with the tearing platform to form the angle a is required to be larger than h1. In the practical tearing process of the polarizing plate 10, since the angle of the pneumatic maintaining device 40 can be adjusted, the angle a can be adjusted according to different requirements.

As the tearing platform 30 moves, the pneumatic maintaining device 40 faces towards the side of the tear-initiation edge 11 originally contacting the liquid crystal panel 20; then the pneumatic maintaining device 40 is turned on to blow air of high pressure onto the tear-initiation edge 11 of the polarizing plate 10, the tear-initiation edge 11 thus is kept at the torn-away state. This can allow the polarizing plate 10 to be torn semi-automatically and further improves the controllability of the tearing process of the polarizing plate 10, and thus improves the yield rate of the liquid crystal panel 20.

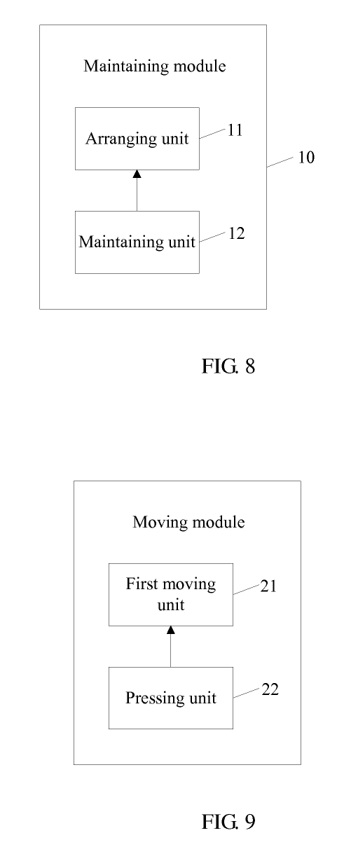

Referring to FIG. 9, which is a schematic view of the moving module 002. In the embodiment, the moving module 002 includes a first moving unit 0021 and a pressing unit 0022. The first moving unit 0021 is used for moving the pneumatic maintaining device and the tearing platform on which the liquid crystal panel is placed to allow the tear-initiation edge to abut the rear tearing roller. The pressing unit 0022 is used for pressing down the rear tearing roller to allow the tear-initiation edge to be located between the front tearing roller and the rear tearing roller.

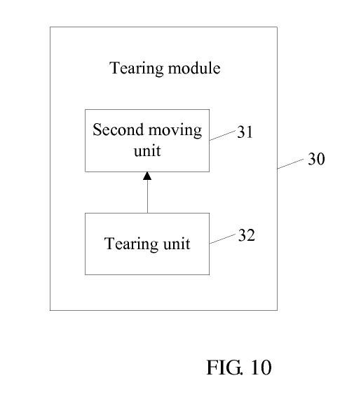

Referring to FIG. 10, which is a schematic view of the tearing module 003. In the embodiment, the tearing module 003 includes a second moving unit 0031 and a tearing unit 0032. The second moving unit 0031 is used for moving the tearing clamper such that the tearing clamper can be located above the front tearing roller and the rear tearing roller. The tearing unit 0032 is used for clamping the tear-initiation edge in the tearing clamper and further tearing the polarizing plate after the tear-initiation edge enters the tearing clamper.

Referring to FIGS. 6a and 6b, after the tear-initiation edge 11 of the polarizing plate is torn away from the liquid crystal panel 20 for an appropriate length, the liquid crystal panel 20 with the polarizing plate 10 attached thereon is placed on the tearing platform 30. The first moving unit 0021 simultaneously moves the tearing platform 30 and the pneumatic maintaining device 40, thus, the pneumatic maintaining device 40 is capable of supplying air of high pressure to keep the tear-initiation edge 11 at the torn-away state as the tearing platform 30 moves. During the process, as shown in FIG. 6b, the front tearing roller 50 is distant away from the rear tearing roller 60 and is located above the rear tearing roller 60. After the tear-initiation edge 11 abuts the rear tearing roller 60, the pressing unit 0022 presses the front tearing roller 50 down, which moves the front tearing roller 50 to along the direction shown by the arrow shown in the FIG. 6b to be located on the same horizontal level as the rear tearing roller 60.

After the platform 30 and the pneumatic maintaining device 40 are moved to the position allowing the tear-initiation edge 11 to abut the rear tearing roller 60, the front tearing roller 50 is pressed down to allow the tear-initiation edge 11 to be located between the front tearing roller 50 and the rear tearing roller 60, thus, the front tearing roller 50 and the rear tearing roller 60 are capable of clamping the tear-initiation edge 11. In this way, the polarizing plate 10 is capable of entering the tearing clamper 70 as the tearing platform 30 moves on.

Referring also to FIGS. 6c, 6d, and 6e, as shown in FIG. 6c, after the front tearing roller 50 is pressed down to allow the tear-initiation edge 11 to be located between the front tearing roller and the rear tearing roller 60, the tearing clamper 70 is properly positioned, that is, the tearing clamper 70 is moved to be located above the front tearing roller 50 and rear tearing roller 60 by the second moving unit 0031. As shown in FIG. 6d, as the tearing platform 30 moves on, the front tearing roller 50 and the rear tearing roller 60 clamps the tear-initiation edge 11 to gradually tear the rest part of the polarizing plate 10 away from the liquid crystal panel 20. During the process, the polarizing plate 10 extends upwards between the front tearing roller 50 and the rear tearing roller 60 to allow the tear-initiation edge 11 to be located in the tearing clamper 70. As shown in FIG. 6e, after the polarizing plate 10 is determined to enter the tearing clamper 70, the tearing clamper 70 clamps the polarizing plate and moves along the same direction as the tearing platform 30. At this time, since the front tearing roller 50 and the rear tearing roller 60 are fixed, thus, the polarizing plate 10 is capable of extending upwards between the front tearing roller 50 and the rear tearing roller 60 by the tearing clamper 70 and being completely torn away from the liquid crystal panel 20. Therefore, the tearing process of the polarizing plate 10 is finished.

After the tear-initiation edge 11 is clamped between the front tearing roller 50 and the rear tearing roller 60, the tearing clamper 70 is moved to be located above the front tearing roller 50 and the rear tearing roller 60. Thus, after the tear-initiation edge 11 enters the tearing clamper 70, the tearing clamper 70 is capable of clamping the tear-initiation edge. In this way, the tearing unit 002 can use the tearing clamper 70 to completely tear the polarizing plate 10 away from the liquid crystal panel 20 to finish the tearing process of the polarizing plate 10, which allows the polarizing plate 10 to be torn semi-automatically, simplifies manual tearing process of the polarizing plate 10, and improves the yield rate of the liquid crystal panel as well as reduces the industry safety risks.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A tearing method for tearing a polarizing plate, comprising:
after a tear-initiation edge of the polarizing plate defectively attached on a liquid crystal panel is torn away from the liquid crystal panel, turning on a pneumatic maintaining device to keep the tear-initiation edge at a torn-away state;
moving the pneumatic maintaining device and a tearing platform on which the liquid crystal panel is placed to allow the tear-initiation edge to be located in a tearing assembly which comprises a front tearing roller and a rear tearing roller for clamping the polarizing plate during the tearing process of the polarizing plate and a tearing clamper for clamping the tear-initiation edge and further tearing the polarizing plate; and
clamping the tear-initiation edge in the tearing assembly and further tearing the polarizing plate by the relative movement between the tearing platform and the tearing assembly.

2. The tearing method as claimed in claim 1, wherein an angle of air supplied from the pneumatic maintaining device is adjustable.

3. The tearing method as claimed in claim 2, wherein in the process of tearing the polarizing plate by the relative movement between the tearing platform and the tearing assembly, the liquid crystal panel abuts an abutting roller located under the rear tearing roller.

4. The tearing method as claimed in claim 3, wherein the step of turning on a pneumatic maintaining device to keep the tear-initiation edge at a torn-away state comprises:
facing the pneumatic maintaining device towards one side of the tear-initiation edge originally contacting the liquid crystal panel; and
turning on the pneumatic maintaining device to supply air of high pressure to keep the tear-initiation edge at the torn-away state.

5. The tearing method as claimed in claim 4, wherein the step of moving the pneumatic maintaining device and a tearing platform on which the liquid crystal panel is placed to allow the tear-initiation edge to be located in a tearing assembly comprises:
simultaneously moving the pneumatic maintaining device and the tearing platform to allow the tear-initiation edge to abut the rear tearing roller; and
pressing the front tearing roller down to allow the tear-initiation edge to be located between the front tearing roller and the rear tearing roller.

6. The tearing method as claimed in claim 5, wherein the step of clamping the tear-initiation edge in the tearing assembly and further tearing the polarizing plate comprises:
moving the tearing clamper to be located above the front tearing roller and the rear tearing roller; and
after the tear-initiation edge enters the tearing clamper, clamping the tear-initiation edge in the tearing clamper and further tearing the polarizing plate.

7. A tearing method for tearing a polarizing plate, comprising:
after a tear-initiation edge of the polarizing plate defectively attached on a liquid crystal panel is torn away from the liquid crystal panel, turning on a pneumatic maintaining device to keep the tear-initiation edge at a torn-away state;
moving the pneumatic maintaining device and a tearing platform on which the liquid crystal panel is placed to allow the tear-initiation edge to be located in the tearing assembly; and
clamping the tear-initiation edge in the tearing assembly and further tearing the polarizing plate.

8. The tearing method as claimed in claim 7, wherein an angle of air supplied from the pneumatic maintaining device is adjustable.

9. The tearing method as claimed in claim 8, wherein when the polarizing plate is torn away from the liquid crystal panel, the liquid crystal panel abuts an abutting roller located under the rear tearing roller.

10. The tearing method as claimed in claim 9, wherein the step of turning on a pneumatic maintaining device to keep the tear-initiation edge at a torn-away state comprises:
facing the pneumatic maintaining device towards one side of the tear-initiation edge originally contacting the liquid crystal panel; and
turning on the pneumatic maintaining device to supply air of high pressure to keep the tear-initiation edge at the torn-away state.

11. The tearing method as claimed in claim 9, wherein the tearing assembly comprises a front tearing roller, a rear tearing roller, and a tearing clamper; the front tearing roller and the rear tearing roller are used for clamping the polarizing plate during the process of tearing the polarizing plate, and the tearing clamper is used for clamping the tear-initiation edge and tearing the polarizing plate.

12. The tearing method as claimed in claim 11, wherein the step of moving the pneumatic maintaining device and a tearing platform on which the liquid crystal panel is placed to allow the tear-initiation edge to be located in a tearing assembly comprises:
simultaneously moving the pneumatic maintaining device and the tearing platform at the same time to allow the tear-initiation edge to abut the rear tearing roller; and
pressing the front tearing roller down to allow the tear-initiation edge to be located between the front tearing roller and the rear tearing roller.

13. The tearing method as claimed in claim 12, wherein the step of clamping the tearing clamper in the tearing assembly and further tearing the polarizing plate comprises:
moving the tearing clamper to be located above the front tearing roller and the rear tearing roller; and
after the tear-initiation edge enters the tearing clamper, clamping the tear-initiation edge in the tearing clamper and further tearing the polarizing plate.

14. A tearing apparatus for tearing a polarizing plate, comprising:
a maintaining module for turning on a pneumatic maintaining device after a tear-initiation edge of the polarizing plate defectively attached on a liquid crystal panel is torn away from the liquid crystal panel so that the pneumatic maintaining device is capable of keeping the tear-initiation edge at a torn-away state;
a moving module for moving the pneumatic maintaining device and a tearing platform on which the liquid crystal panel is placed to allow the tear-initiation edge to be located in the tearing assembly; and
a tearing module for clamping the tear-initiation edge in the tearing assembly and further tearing the polarizing plate.

15. The tearing apparatus as claimed in claim 14, wherein the maintaining module comprises an arranging unit and a maintaining unit, the arranging unit is used for arranging the pneumatic maintaining device in a way of facing towards one side of the tear-initiation edge originally contacting the liquid crystal panel, and the maintaining unit is used for turning on the pneumatic maintaining device to supply air of high pressure to keep the tear-initiation edge at the torn-away state.

16. The tearing apparatus as claimed in claim 14, wherein the tearing assembly comprises a front tearing roller, a rear tearing roller, and a tearing clamper; the front tearing roller and the rear tearing roller are used for clamping the polarizing plate during the process of tearing the polarizing plate, and the tearing clamper is used for clamping the tear-initiation edge and tearing the polarizing plate.

17. The tearing apparatus as claimed in claim 16, wherein the moving module comprises a first moving unit and a pressing unit; the first moving unit is used for simultaneously moving the pneumatic maintaining device and the tearing platform to allow the tear-initiation edge to abut the rear tearing roller, and the pressing unit is used for pressing the front tearing roller down to allow the tear-initiation edge to be located between the front tearing roller and the rear tearing roller.

18. The tearing apparatus as claimed in claim 17, wherein the tearing module comprises a second moving unit and a tearing unit, the second moving unit is used for moving the tearing clamper to be located above the front tearing roller and the rear tearing roller, and the tearing unit is used for clamping the tear-initiation edge in the tearing clamper and tearing the polarizing plate after the tear-initiation edge enters the tearing clamper.
